(19) United States
(12) Patent Application Publication
(10) Pub. No.: US 2020/0294142 A1
(43) Pub. Date: Sep. 17, 2020

(54) METHOD AND APPARATUS FOR IMPLEMENTING COMMODITIES EXCHANGE USING DISTRIBUED LEDGER TECHNOLOGY

(71) Applicants: Stephen Edkins, Singapore (SG); Frank Gouverne, Lachen (CH)

(72) Inventors: Stephen Edkins, Singapore (SG); Frank Gouverne, Lachen (CH)

(21) Appl. No.: 16/458,411

(22) Filed: Jul. 1, 2019

Related U.S. Application Data
(60) Provisional application No. 62/691,974, filed on Jun. 29, 2018.

(51) Int. Cl. G06Q 40/04; H04L 9/06; G06Q 20/40

(52) U.S. Cl. CPC G06Q 40/04; G06Q 20/405; H04L 9/0637

(57) ABSTRACT

The system provides a distributed ledger based platform for trading and delivering commodities as well as other goods and services. The system allows participants to exchange trade requests, reach an agreement, create a smart contract involving buyer/seller and other service providers like shipping, insurance and inspection companies, generate notifications that actions are required from those parties and form a decentralized consensus among the relevant parties that those actions have been fulfilled

This patent application claims priority to U.S. Provisional Patent Application Ser. No. 62/691,974 filed on Jun. 29, 2018 which is incorporated by reference herein in its entirety.

### BACKGROUND OF THE SYSTEM

A commodities exchange is a system where commodities and representations of commodities, along with futures contracts, maybe bought, sold, and traded. A futures contract is a legal agreement to buy or sell something at a predetermined price at a specified future time. In the context of a commodities exchange, the “something” is a commodity, such as an agricultural commodity (e.g. rice, corn, pork bellies, oranges, and the like) or other commodities, including metals (e.g. gold and silver).

A problem with many commodities exchanges is that the ultimate buyer and seller of a commodity are separated by multiple levels of brokers and other middlemen who add to the price of the commodity and who add opacity to the commodity market. Furthermore, where physical delivery is required a number of other participants such as transport and insurance providers will need to be party to the trade creating extra complexity.

A problem with current commodities exchanges is the need for paper based settlement of transactions. Such a system is costly in time and money. In addition, it is difficult to detect forged or fraudulent documents. Further, there is no real-time visibility to all parties of the progress of the documentation of transactions. Notifications of progress in the transaction are not sent automatically, but rather depend on each participant to manually provide visibility into the status of the transaction.

Another disadvantage of the prior art is the inability to validate unknown trading partners without significant effort. The current system relies on trust that may be unfounded. Unknown trading partners would need to be vetted properly to have a sufficient degree of trust.

### SUMMARY

The system provides a distributed ledger based platform for trading and delivering commodities as well as other goods and services. The system allows participants to exchange trade requests, reach an agreement, create a smart contract involving buyer/seller and other service providers like shipping, insurance and inspection companies, generate notifications that actions are required from those parties and then forms a decentralized agreement among the relevant parties that those actions have been fulfilled.

Trade events will be recorded on a permissioned non-repudiatable log that can be accessed by the parties to the trade. Historical trades are recorded on an immutable database that allows market participants to accurately assess each other's track record. Data relating to the execution of the trade is linked to this event log. It may be received in document form or where fuller integration is possible these documents may be replaced by an API or equivalent data transfer.

The system provides for much smoother operation of a commodities market by allowing producers to interact directly with buyers and then automatically create a smart contract for physical delivery with service providers automatically integrated. The system provides real-time notifications of transaction events in the exchange process. Title and payment are irrevocable and handled automatically through the system. The system qualifies participants so that unknown trading partners can have a degree of trust when undertaking a transaction.

### BRIEF DESCRIPTION OF THE DRAWINGS

FIG. 1 illustrates an embodiment of the system.

FIG. 2 is an expanded view of the Exchange 103 of FIG. 1.

FIG. 3 is a flow diagram of the operation of an embodiment of the system.

FIG. 4 is an illustration of a dashboard in an embodiment of the system.

FIG. 5 is an illustration of a Trade Request interface in an embodiment of the system.

FIG. 6 is an illustration of an Exchange interface in an embodiment of the system.

FIG. 7 is an illustration of a More Info interface of FIG. 6 in an embodiment of the system.

FIG. 8 is an illustration of a smart contract generation in an embodiment of the system.

FIG. 9 is an example computer system.

### DETAILED DESCRIPTION OF THE SYSTEM

The system provides a distributed immutable ledger based system to provide a transparent commodities market between sellers and buyers. Many commodities markets suffer from a lack of transparency. The present system will be described herein in connection with a rice exchange. However, the system has equal application to any commodity exchange or other goods and services.

Rice is characterized by having a variety of types and finishes, making it difficult to provide homogeneous pricing. Other aspects of the rice market have exacerbated this, for example, there is no liquid futures market for rice trade globally. This means that it is not possible for market participants to hedge against price risk and there is relatively little involvement from large agricultural trading firms. Instead producers must accept whatever the market price is at the time of harvest and traders will be subject to price volatility while product is being delivered. Delivery can take two months or more in many circumstances.

Another problem that the rice market has in common with other physical commodity trading is the complexity and inefficiencies in the way trades are executed and settled. There are a number of stakeholders in the rice value chain linking producers to consumers. These players include farmers, collectors, rice millers, wholesalers, retailers, and consumer. In addition to these waypoints, distributors play a key role in the process. Each link in the chain requires documentation. The documents must be checked and matched manually which is expensive, time consuming, and mistake prone. In addition, the documents physically travel through the rice market chain, with corresponding risk of loss.

Further, because there are a large number of participants in the rice market chain, it is difficult to have confidence or a level of trust with unknown or first-time participants. This can lead to participants only trading with known partners, leading to market inefficiencies, and loss of opportunity for producers, buyers, and sellers.

Another problem with the current rice market is the effect of policy measures on rice prices. Tariffs and other protectionist measures implemented by rice producing and rice consuming countries can account for nearly half of the change in international rice trading prices. An integrated and transparent market would provide for price stabilization.

The invention of distributed ledgers (including blockchain, hashgraph, and the like) has provided a platform and technology that can be used to create a trustworthy, integrated, and stable rice market. The system is described in relation to the rice market, but has equal implementation to all commodities markets, whether for agricultural goods or non-agricultural goods. The use of distributed ledger technology affords benefits that directly address the inherent inefficiencies of the rice market: vast document processing requirements with costly delays and human error; frequent contractual disputes arising from multiple interpretations of clauses, further harming business, or in effect killing the deal.

In one embodiment, the system utilizes blockchain technology to implement the distributed ledger. The blockchain process, whereby each block is built on its predecessor and validated by community consensus, eradicates subjective manipulation of a trade, and creates an immutable audit trail at every step. In addition, the digital nature of the blockchain prevents lost documents. In one embodiment the system uses a hashgraph to implement the distributed ledger.

The system provides a common immutable ledger platform that allows participants to trade and commercialize rice. In one optional embodiment, users of the marketplace use cryptocurrency tokens to transact in the marketplace. The tokens in one embodiment are used to pay service fees associated with a transaction in the exchange, but not used for the trade itself. In one embodiment, the tokens may also be used for the trade. In one embodiment the tokens may be used to pay to record information.

The distributed ledger based platform of the system for trading commodities as well as other goods and services which allows participants to exchange trade requests, reach an agreement, create a smart contract, notify the different participants, where necessary create automatically populated e-documents and emit them to the contractual parties by the participants or service providers or third parties, record receipt of returned documents or data, using matching tools to confirm completion as well as any discrepancies and modifications with respect to the smart contract.

Once all the documents specified in the smart contract have been received the platform will trigger automatic payment and/or title transfer. All the events described above will be presented on an audit log which can be viewed by all authorised participants both during the course of the trade and also subsequently. Held on a common ledger this data will be immutable and reliable for all participants allowing them to demonstrate bona fides to others users of the platform.

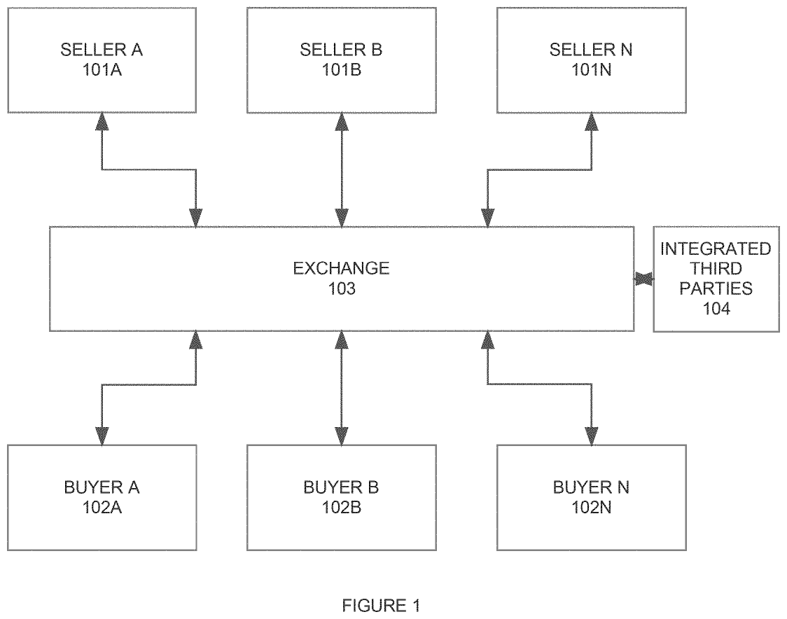

FIG. 1 illustrates an embodiment of the system. A plurality of commodity Sellers 101A, 101B, . . . 101N represent sellers/producers of a commodity (e.g. rice). A plurality of Buyers 102A, 102B, . . . 102N represent purchases of the commodity from one or more of the Sellers. Transactions are arranged through the Exchange 103 of the system. The Exchange 103 is used to handle trade requests, emit the documents, confirm milestones, issue payment, transfer title, and the like via a digital platform.

In one embodiment, each Buyer accesses the Exchange 103 via their own processing devices, via a network connection (e.g. the internet). The Exchange 103 may be implemented on a secure server or in the cloud. A Buyer may use an application and/or a browser interface to access the Exchange 103. Similarly, the Sellers interact with the Exchange 103 via a network connection.

In one embodiment all communication between Sellers and Buyers is through the Exchange 103. In this manner all transactions can be tracked and automatically updated as necessary.

The system also includes the ability to integrate third parties 104. These third parties include bankers, insurance companies, shipping companies, inspectors, and the like. Because the system validates and qualifies participants, and keeps company information and historical trading data, the third parties can make more accurate risk assessments. Similarly, trade participants will be able to check data on third parties, improve pricing comparison, performance, service, and the like.

Trade Process

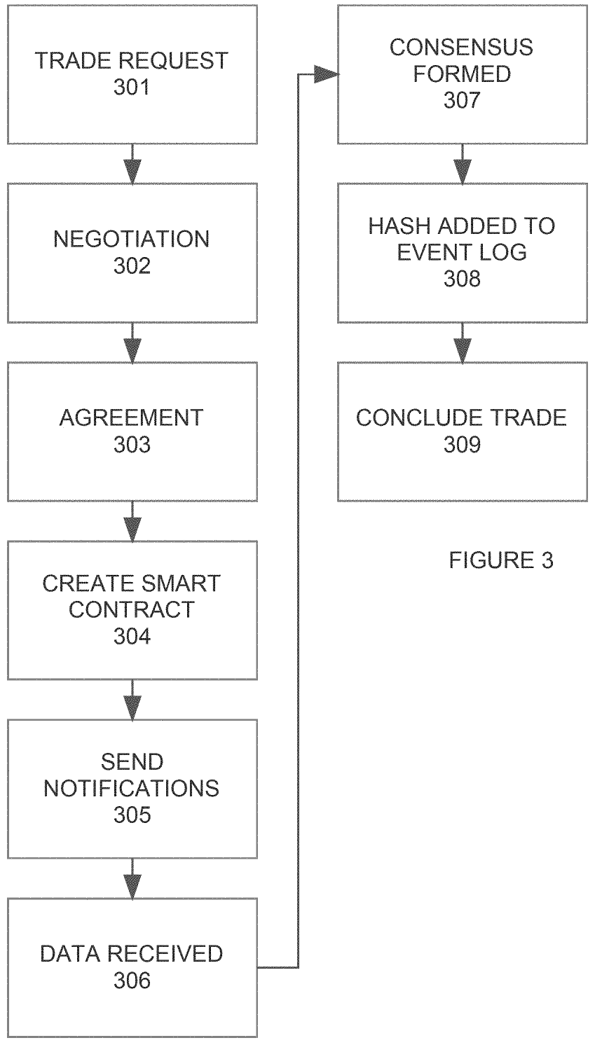

FIG. 3 is a flow diagram of the operation of an embodiment of the system. At step 301 a trade request is initiated between a Buyer 102 and Seller 101. The trade request may be open ended. That is a Seller may offer to sell a commodity at a certain price to any Buyer. Alternatively, a Buyer may offer to buy a commodity at a certain price from any Seller. In one embodiment, one party makes an offer to a specific party to complete a trade or transaction.

Using the system, for example, a Buyer selects the Seller's offer. The system allows the parties to communicate with each other and to negotiate at step 302 the parties negotiate the trade request until agreement is reached at step 303.

Once the parties agree to the trade at step 303, the system automatically generates and prepopulates a Smart Contract at step 304. In one embodiment, the system utilizes blockchain technology to provide an immutable record via a distributed ledger. This provides trust in the system and prevents one party from modifying terms without consent of the other party. The system also provides for online and automatic generation of supporting documentation in an embodiment. Such documentation may be requested by one of the parties, by third parties involved in completion of the contract (e.g. shipping companies, bankers, inspectors, insurance companies, and the like). The supporting documents may include an invoice, bill of lading, certificate of quality, certificate of origin, export declaration, insurance certificate, non-GMO certificate, phylo-sanitary certificate, certificate of fumigation, shipping advice, certificate of weight, track and trade, sustainability, provenance and the like.

The system prepopulates the supporting documents with data from the trade. The system may already know that certain documents are conditional and may put holds on other steps in the process until a condition is met. In other cases, the system can query whether a document creates a conditional trigger, allowing the user to customize the system accordingly. In one embodiment, the particular incoterm selected will include known conditional documents that are automatically included in the trade process. It should be noted that third party documentation may represent transactions that require payment. The system can provide automatic escrow of payments that are only released when conditions (e.g. submission of completed signed documents, confirmations of completion, and the like) are met. In other cases, the completion of a condition may trigger a request for manual payment of a fee to or from a third party.

The system allows for integration with third parties by allowing them permission levels to access certain parts of the transaction related to their participation. The third parties can then monitor the completion of documentation related to them, and the system can automatically notify parties when such documentation or other metrics have been completed. For example, the system can notify parties when a shipping company picks up the commodity, reaches transit waypoints, and delivers the commodity.

Notifications are provided in the system at step 305. As noted above, the notifications may be generated as a result of actions by the Buyer and Seller, and/or third party partners associated with the trade. The notifications are sent to the appropriate parties so that conditional steps can be known to be completed, triggering next steps in the trade. (e.g. no shipping until insurance is obtained and payment is made, depending on the contract selected by the parties).

At step 306 the system receives data related to the transaction. If the data is such that it will be added to the distributed ledger, the rules of the Smart Contract must be followed. In one embodiment, the system requires unanimous agreement between all parties before approving a change or update to the Smart Contract. At step 308 the system adds a hash to the event log representing the approved change/update to the Smart Contract. The changes are maintained in an immutable distributed ledger showing who made the change, the time of the change, and other meta-data. At step 309 the trade is concluded when all conditions have been met and all data matches the terms of the smart contract.

In one embodiment, the system uses the Hyperledger Blockchain Algorithm to implement the distributed ledger. The system is not limited to Hyperledger but may use any blockchain technology, hashgraph, or any other suitable technology to implement the distributed ledger.

Exchange

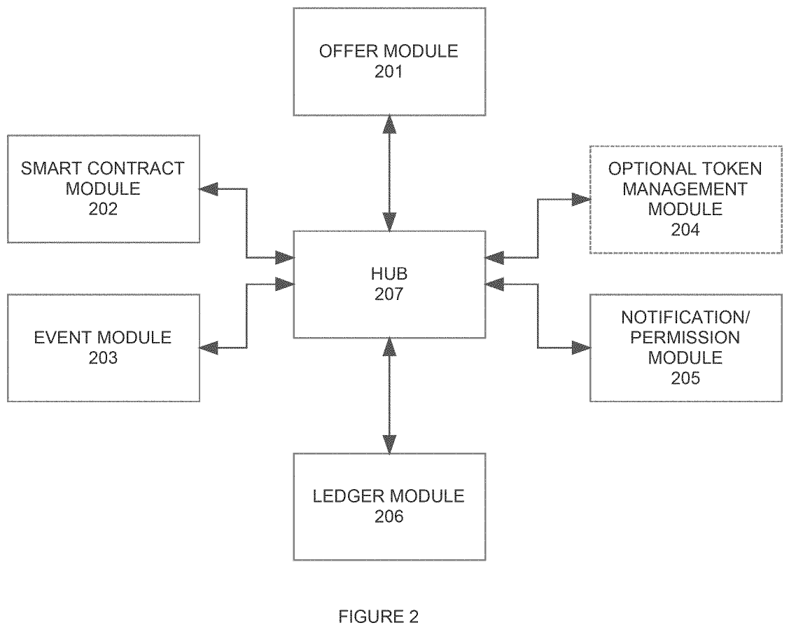

FIG. 2 is an expanded view of the Exchange 103 of FIG. 1 in one embodiment. The Exchange 103 may be implemented as a server based system with associated storage and communication capabilities. In one embodiment, the system integrates a plurality of software modules and capabilities into a practical application for executing trades on an exchange. The modules communicate with one another through hub 207 in an embodiment of the system. The system provides advantages in the practical application that greatly improve the system and include the ability to have trusted immutable data, settlement of trades through smart contract, irrevocable payment and transfer of title, real-time or near-real-time notifications; integration with third party service providers in addition to the Buyer and Seller, validation of system members When a user registers with the system, the user must provide qualifying and validating information that can provide trustworthiness to others in the system. In addition, the system maintains company information and historical trading data on the distributed ledger so that other parties can view that information and make informed decisions before trading with an unknown counterparty.

Some markets have implemented a KYC (i.e. “know your customer” or “know your client”) system. The term is also used to refer to the bank regulations and anti-money laundering regulations which govern trading and commodity activities. The system allows KYC procedures to be part of the qualification of participants in one embodiment.

Offer Module

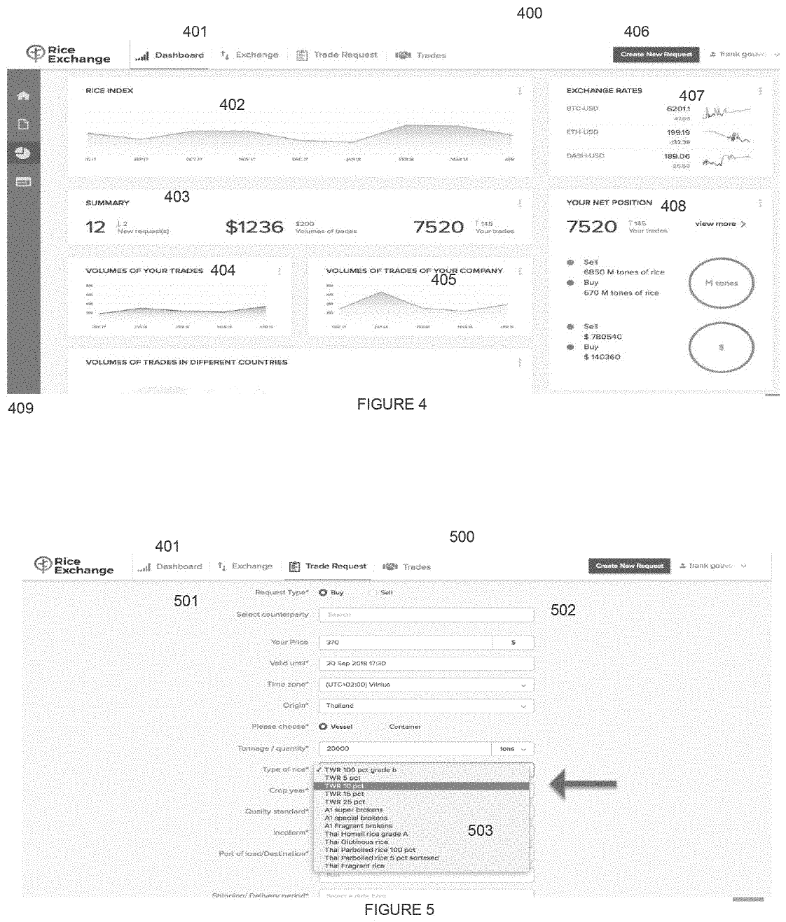

The Exchange 103 comprises an Offer Module 201 where Sellers can offer an amount and price of the available commodity, a Buyer can offer a desired price and amount of the commodity, and the Buyer and Seller can consummate an offer and acceptance. The Offer Module 201 is configured to provide the functionality needed to propose, view, and confirm a trade using the system. Offer Module 201 is configured to cause the system to present the interface of FIG. 4 to the user and implements steps 301, 302, and 303 of FIG. 3.

In one embodiment, the user accesses the system via a dashboard that allows the user (e.g. Buyer and/or Seller) to access the functionalities of the system. FIG. 4 illustrates a home interface in one embodiment of the system. The interface 400 includes region 401 where the user can select Dashboard, Exchange, Trade Request, or Trades tabs. Region 402 provides an updated graphical index of the price of the commodity (e.g. rice). This information may be obtained from third party sources. In one embodiment, the index is based on transactions made on the system and system participants. Data from the system provides an improved index that more accurately reflects the market. Another advantage of the system is that the transaction data can help enable a liquid futures market in the commodity, particularly in rice where there has been a lack of a liquid futures market. The system will provide insight and into trading patterns and can use machine learning to provide additional meaning from the trading patterns.

Another advantage of the system data is that shipping companies can view patterns of trade requests and seasonality effects and more efficiently plan capacity, positioning of vessels and vehicles, timing, pricing, and the like. The ability to have integrated third parties on the platform, such as shipping companies, allows more accurate and timely quoting and creates the ability to reach new customers and markets.

Similarly, insurance companies can use the data to see patterns of claims on different routes and geographies with different customers, allowing for customized pricing of risk products. Further, the points of problems, risk, and culpability can be identified and used to improve the handling of claims. In one embodiment, the identification of risks allows prophylactic action to minimize and/or eliminate the risks.

Banks can have greater confidence in title transfers being accomplished when payment is made. Banks also will have better historical data to weight credit risks.

Region 403 provides a summary of trading activity including New Requests, dollar Volume of Trades, and Your Trades Region 404 provides a graphical representation of the trades of the user in different countries. Region 405 is a graphical representation of volumes of trades of a company of which the user may be a member.

Region 406 is a button that can be selected to create a new proposed trade. Region 407 displays current exchange rate information and can be customized to the currencies of interest to the user. Region 408 illustrates the net position of the user based on their buy and sell contracts. Region 409 is a bar where the user can select Home, Documents, the current display, and the like.

FIG. 5 is an illustration of a Trade Request interface 500 in an embodiment of the system. It can be seen that in region 401, the tab for Trade Request is highlighted. The interface includes region 501 to indicate if the request type is to buy or sell the commodity with open positions or choosing a specific counterparty. Region 502 allows the counterparty to be selected.

The interface 500 includes a plurality of fields that are useful in implementing the trade request. These fields include, but are not limited to, Price, Valid Offer Date, Time Zone, Origin, method of shipment (e.g. vessel or container), Tonnage, Type of Commodity (e.g. type of rice); Crop Year, Quality Standard, Incoterm (Incoterm is the set of rules that will define the responsibilities of sellers and buyers for the delivery of goods under a sales contract. They are published by the International Chamber of Commerce and are often used in commercial transactions), Port (of load and/or destination); Shipping/Delivery Period, and the like. The fields may be buttons or pull down menus. For example, FIG. 5 shows the pull down menu 503 of Type of Rice, which allows the user to select the type of rice of the transaction.

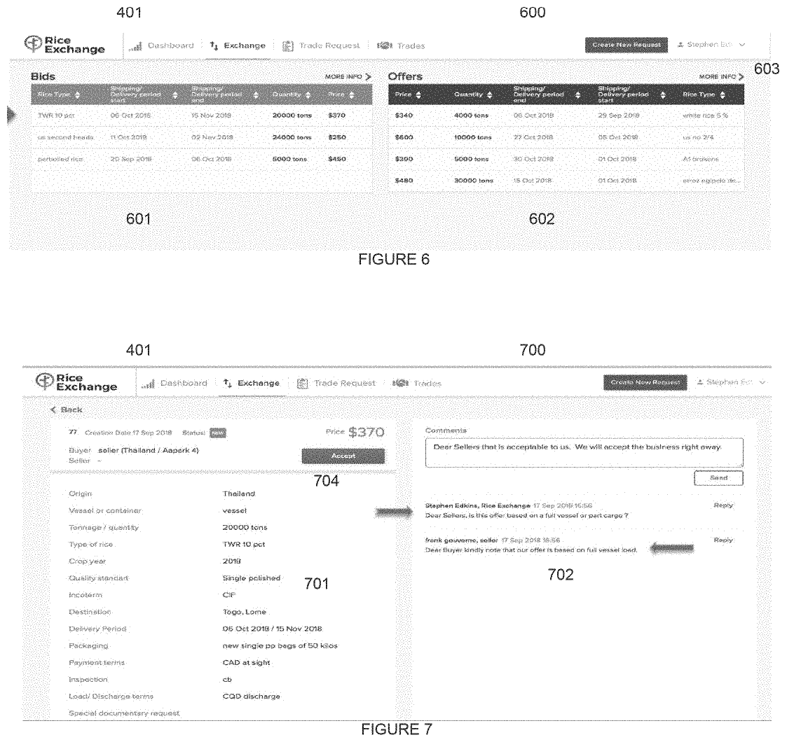

Once the user has completed the required fields in the Trade Request interface 500, the bid may be viewed by selecting the Exchange tab in region 401. The Exchange interface 600 is illustrated in FIG. 6. The Exchange interface 600 includes region 601 that shows the ids and region 602 that shows the Offers. In the example shown, the Bid on the first line in region 601 is the Bid generated in FIG. 5. The Exchange interface 600 includes a “More Info” button 603 that can be used by a potential Buyer or Seller (depending on the type of trade) to obtain more information and to act on the trade.

FIG. 7 is an interface 700 showing the More Info of a selected Bid or Offer from FIG. 6. The interface 700 includes a region 701 that shows the details of the Bid, namely the terms selected by the user in FIG. 5. Region 702 is an Instant Chat region where the Seller and Buyer can discuss the trade, obtain any additional information, negotiate possible changes, and discuss other details related to the trade. If the Buyer decides to accept the trade, the Buyer uses the Accept button 704 to confirm the trade.

Smart Contract Module

A Smart Contract module 202 is used to implement steps 304, 306, 307, and 308 of FIG. 3 and to automatically generate a distributed ledger based smart contract between the Buyer and the Seller. It should be noted that any suitable distributed ledger technology may be used without departing from the spirit and scope of the system.

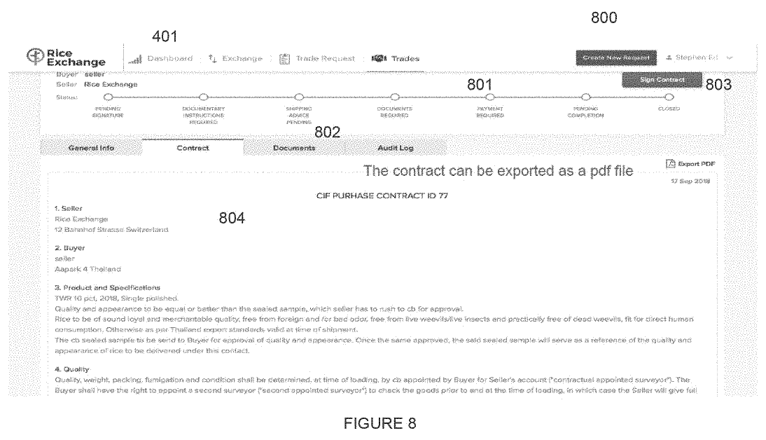

In one embodiment, the system allows the user to control their own information on the system distributed ledger, provide permission controls to allow access to parties to contract with the user, and provide identity verification and true validity of data. Once the trade has been confirmed by a Buyer and Seller, the system uses the Smart Contract Module to generate the Smart Contract used by the system and generates and controls the interface of FIG. 8.

FIG. 8 illustrates an interface 800 showing Smart Contract generation in an embodiment of the system. The Smart Contract Module 202 facilitates the automatic generation and population of a contract which is displayed in region 804. Region 802 allows the user to choose General Info, Contract, Documents, or Audit Log tabs. The interface provides a timeline 801 that shows when certain tasks have been completed, making it easier to instantly see the completion status of a trade.

The timeline in one embodiment includes entries for Pending Signature, Documentary Instructions Required, Shipping Advice Pending, Documents Required, Payment Required, Pending Completion, and Closed.

In the example shown, the Seller has selected the CIF contract from the Incoterms in FIG. 5. The CIF (Cost, Insurance, and Freight) is an example of the 12 incoterms established by the International Chamber of Commerce. When the Buyer accepted the trade in FIG. 7, the system automatically populated the CIF contract with the terms of the offer and acceptance (e.g. parties, price, type, shipment dates, and the like). The use of incoterms instead of custom contracts can allow for streamlining of trades and reduces negotiation over standard terms. However, custom contracts can be used with the system if desired.

Once the Buyer has reviewed the populated contract 804, the Buyer can Sign the contract using the Sign Contract button 803. Participants in the system have agreed to electronic signature terms when enrolling into the system, allowing for quicker turn-around in trades. Because the Smart Contract Module 202 uses distributed ledger technology, the terms of the contract cannot be modified unless both parties agree.

Event Module 203 is used to track events related to the transactions, so that conditional events can be determined, and smart contract provisions can be executed. Event Module 203 implements steps 305 and 306 of FIG. 3.

Optional Token Management Module 204 is used to process and issue cryptocurrency tokens related to the transaction (e.g. for services fees related to the transaction). In one optional embodiment the system utilizes cryptocurrency issued to users of the system for service fees and in one embodiment also used to transact trades. When a user joins the marketplace, the user buys a minimum number of cryptocurrency tokens for use in transacting trades. However, the system does not require the use of cryptocurrency and may be operated without the use of cryptocurrency.

Notification/Permission Module 205 is used to provide notifications in step 305 of FIG. 3 to parties and to provide permissions for appropriate third parties to participate in transactions and notifications. In addition to the Buyer and Seller, the system may include third parties such as bankers, inspectors, shipping companies, and insurers as authorized parties. All parties can review the latest updates on the transaction and receive notifications when all requirements of the trade have been fulfilled.

Ledger Module 206 is used to generate a distributed ledger that is updated and validated pursuant to the terms of the smart contract. Ledger Module implements step 308 in FIG. 3.

### Example Computer System

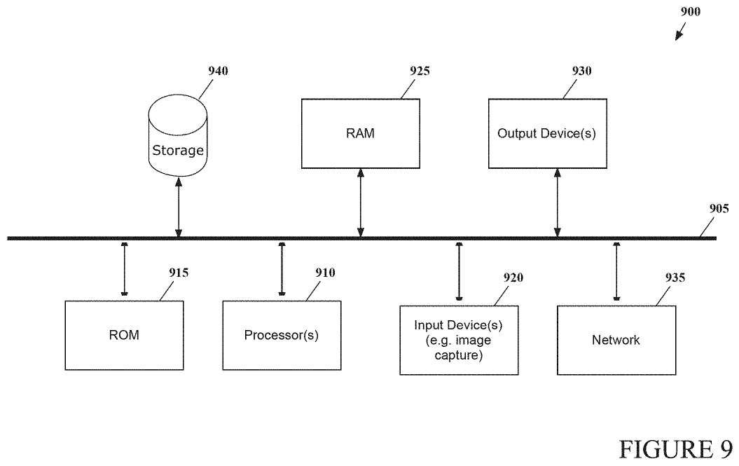

FIG. 9 illustrates an exemplary a system 900 that may implement the system. The electronic system 900 of some embodiments may be a mobile apparatus. The electronic system includes various types of machine readable media and interfaces. The electronic system includes a bus 905, processor(s) 914, read only memory (ROM) 915, input device(s) 920, random access memory (RAM) 925, output device(s) 930, a network component 935, and a permanent storage device 940.

The bus 905 communicatively connects the internal devices and/or components of the electronic system. For instance, the bus 905 communicatively connects the processor(s) 910 with the ROM 915, the RAM 925, and the permanent storage 940. The processor(s) 910 retrieve instructions from the memory units to execute processes of the invention.

The processor(s) 910 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 910, they cause the processor(s) 910 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 910. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 900, define one or more specific machine implementations that execute and perform the operations of the software programs.

The ROM 915 stores static instructions needed by the processor(s) 910 and other components of the electronic system. The ROM may store the instructions necessary for the processor(s) 910 to execute the processes provided by the system. The permanent storage 940 is a non-volatile memory that stores instructions and data when the electronic system 900 is on or off. The permanent storage 940 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 925 is a volatile read/write memory. The RAM 925 stores instructions needed by the processor(s) 910 at runtime, the RAM 925 may also store the real-time video or still images acquired by the system. The bus 905 also connects input and output devices 920 and 930. The input devices enable the user to communicate information and select commands to the electronic system. The input devices 920 may be a keypad, image capture apparatus, or a touch screen display capable of receiving touch interactions. The output device(s) 930 display images generated by the electronic system. The output devices may include printers or display devices such as monitors.

The bus 905 also couples the electronic system to a network 935. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, a method and apparatus for implementing a commodity exchange has been described.

What is claimed is:

1. A method of trading commodities comprising:
in a processing system;
a first user initiating a trade offer of a commodity;
a second user making an acceptance of the trade offer of the commodity;
automatically generating a smart contract including the terms of the offer and acceptance, the smart contract identifying documents and conditions required by the trade;
automatically generating the documents required by the trade;
tracking the completion of the documents by the first and second user;
tracking the conditions required by the trade;
transferring title to the commodity when the smart contract documents have been completed and conditions of the smart contract have been met.

2. The method of claim 1 wherein the smart contract is implemented in a distributed ledger system.

3. The method of claim 2 wherein the distributed ledger is implemented on a blockchain.

4. The method of claim 2 wherein the distributed ledger is implemented by a hashgraph.

5. The method of claim 2 wherein the trade offer includes at least one incoterm.

6. The method of claim 5 wherein the smart contract automatically includes rules for the first user and the second user based on the at least one incoterm.

7. The method of claim 2 wherein all events associated with the trade are stored in an event log in the distributed ledger.

8. The method of claim 1 wherein the first user and the second user are verified by the system prior to the trade.

9. The method of claim 8 further including at least one third party associated with the trade and verified by the system.

10. The method of claim 9 wherein historical data from the trade is stored in the system.
